(19) United States
(12) Patent Application Publication
(10) Pub. No.: US 2021/0318693 A1
(43) Pub. Date: Oct. 14, 2021

(54) MULTI-AGENT BASED MANNED-UNMANNED COLLABORATION SYSTEM AND METHOD

(71) Applicant: ELECTRONICS AND TELECOMMUNICATIONS RESEARCH INSTITUTE, Daejeon (KR)

(72) Inventors: Chang Eun LEE, Daejeon (KR); Sang Joon PARK, Sejong-si (KR); So Yeon LEE, Sejong-si (KR); Vladimirov Blagovest Iordanov, Changwon-si (KR); Jin Hee SON, Daejeon (KR); Sung Woo JUN, Daejeon (KR); Eun Young CHO, Daejeon (KR)

(73) Assignee: ELECTRONICS AND TELECOMMUNICATIONS RESEARCH INSTITUTE, Daejeon (KR)

(21) Appl. No.: 17/230,360

(22) Filed: Apr. 14, 2021

(30) Foreign Application Priority Data
Apr. 14, 2020 (KR) 10-2020-0045586

(51) Int. Cl. G05D 1/02; G05D 1/00; G01S 17/931

(52) U.S. Cl. CPC G05D 1/0291; G05D 1/0088; G05D 1/0214; G01S 17/931; G05D 1/0094

(57) ABSTRACT

Provided is a multi-agent based manned-unmanned collaboration system including: a plurality of autonomous driving robots configured to form a mesh network with neighboring autonomous driving robots, acquire visual information for generating situation recognition and spatial map information, and acquire distance information from the neighboring autonomous driving robots to generate location information in real time; a collaborative agent configured to construct location positioning information of a collaboration object, target recognition information, and spatial map information from the visual information, the location information, and the distance information collected from the autonomous driving robots, and provide information for supporting battlefield situational recognition, threat determination, and command decision using the generated spatial map information and the generated location information of the autonomous driving robot; and a plurality of smart helmets configured to display the location positioning information of the collaboration object, the target recognition information, and the spatial map information constructed through the collaborative agent and present the pieces of information to wearers.

### CROSS-REFERENCE TO RELATED APPLICATION

This application claims priority to and the benefit of Korean Patent Application No. 10-2020-0045586, filed on Apr. 14, 2020, the disclosure of which is incorporated herein by reference in its entirety.

### BACKGROUND

### 1. Field of the Invention

The present invention relates to a multi-agent based manned-unmanned collaboration system and method, and more specifically, to a manned-unmanned collaboration system and method for enhancing awareness of combatants in a building or an underground bunker that is first entered without prior information, a global navigation satellite system (GNSS)-denied environment, or a modified battlefield space of poor quality due to irregular and dynamic motions of combatants.

### 2. Discussion of Related Art

In the related art, a separable modular disaster relief snake robot that provides seamless communication connectivity and a method of driving the same relate to a modular disaster relief snake robot that performs human detection and environmental exploration missions in an atypical environment (e.g., a building collapse site, a water supply and sewage pipe, a cave, a biochemical contamination area) as shown in FIG. 1.

The conventional snake robot is mainly characterized as providing seamless real-time communication connectivity using unit snake robot modules each having both a driving capability and a communication capability to transmit camera image data of a snake robot module 1 constituting a head part by sequentially dividing and converting snake robot modules 2 to n constituting a body part into multi-mobile relay modules to seamlessly transmit image information to a remote-control center.

The existing technology is mainly characterized as transmitting image information of a head part to a remote-control center by forming a wireless network from the body part modules in a row through a one-to-one sequential ad-hoc network configuration without processing of artificial intelligence (AI) based meta-information (object recognition, threat analysis, etc.), and a human manually performing remote monitoring at the remote-control center. However, the technology has numerous difficulties in practice, due to a lack of a function of supporting disaster situation recognition, determination, and command decision through real-time human-robot-interface (HRI) based manned-unmanned collaboration with firefighters in a firefighting disaster prevention site, a limitation in generating spatial information and location information about the exploration space of the snake robots, and a limitation in transmitting high-capacity image information to the remote control center through an ad-hoc network multi hop.

In other words, in practice, the conventional technology has numerous limitations in performing collaborative operation of firefighters and generating spatial information and location information of exploration spaces due to the exclusive operation of unmanned systems at the disaster site.

### SUMMARY OF THE INVENTION

The present invention provides a collaborative agent based manned-unmanned collaboration system and method capable of generating spatial information, analyzing a threat in an operation action area through a collaborative agent based unmanned collaboration system, providing an ad-hoc mesh networking configuration and relative location positioning through a super-intelligent network, alleviating cognitive burden of combatants in battlefield situations through a potential field based unmanned collaboration system and a human-robot-interface (HRI) based manned-unmanned interaction of smart helmets worn by combatants, and supporting battlefield situation recognition, threat determination, and command decision-making.

The technical objectives of the present invention are not limited to the above, and other objectives may become apparent to those of ordinary skill in the art based on the following description.

According to one aspect of the present invention, there is provided a multi-agent-based manned-unmanned collaboration system including: a plurality of autonomous driving robots configured to form a mesh network with neighboring autonomous driving robots, acquire visual information for generating situation recognition and spatial map information, and acquire distance information from the neighboring autonomous driving robots to generate location information in real time; a collaborative agent configured to construct location positioning information of a collaboration object, target recognition information, and spatial map information from the visual information, the location information, and the distance information collected from the autonomous driving robots, and provide information for supporting battlefield situational recognition, threat determination, and command decision using the generated spatial map information and the generated location information of the autonomous driving robot; and a plurality of smart helmets configured to display the location positioning information of the collaboration object, the target recognition information, and the spatial map information constructed through the collaborative agent and present the pieces of information to wearers.

The autonomous driving robot may include a camera configured to acquire image information, a Light Detection and Ranging (LiDAR) configured to acquire object information using a laser, a thermal image sensor configured to acquire thermal image information of an object using thermal information, an inertial measurer configured to acquire motion information, a wireless communication unit which configures a dynamic ad-hoc mesh network with the neighboring autonomous driving robots through wireless network communication and transmits the pieces of acquired information to the smart helmet that is matched with the autonomous driving robot, and a laser range meter configured to measure a distance between a recognition target object and a wall surrounding a space.

The autonomous driving robot may be driven within a certain distance from the matched smart helmet through ultra-wideband (UWB) communication.

The autonomous driving robot may drive autonomously according to the matched smart helmet and provide information for supporting local situation recognition, threat determination, and command decision of the wearer through a human-robot interface (HRI) interaction.

The autonomous driving robot may perform autonomous-configuration management of a wired personal area network (WPAN) based ad-hoc mesh network with the neighboring autonomous driving robot.

The autonomous driving robot may include a real-time radio channel analysis unit configured to analyze a physical signal including a received signal strength indication (RSSI) and link quality information with the neighboring autonomous driving robots, a network resource management unit configured to analyze traffic on a mesh network link with the neighboring autonomous robots in real time, and a network topology routing unit configured to maintain a communication link without propagation interruption using information analyzed by the real-time radio channel analysis unit and the network resource management unit.

The collaborative agent may include: a vision and sensing intelligence processing unit configured to process information about various objects and attitudes acquired through the autonomous driving robot to recognize and classify a terrain, a landmark, and a target and to generate a laser range finder (LRF)-based point cloud for producing a recognition map for each mission purpose; a location and spatial intelligence processing unit configured to provide a visual-simultaneous localization and mapping (V-SLAM) function using a camera of the autonomous driving rotor, a function of incorporating an LRF-based point cloud function to generate a spatial map of a mission environment in real time, and a function of providing a sequential continuous collaborative positioning function between the autonomous driving robots for location positioning of combatants having irregular flows using UWB communication; and a motion and driving intelligence processing unit which explores a target and an environment of the autonomous driving robot, configures a dynamic ad-hoc mesh network for seamless connection, autonomously sets a route plan according to collaboration positioning between the autonomous robots for real-time location positioning of the combatants, and provides information for avoiding a multimodal-based obstacle during driving of the autonomous driving robot.

The collaborative agent may be configured to generate a collaboration plan according to intelligence processing, request neighboring collaboration agents to search for knowledge and devices available for collaboration and review availability of the knowledge and devices, generate an optimal collaboration combination on the basis of a response to the request to transmit a collaboration request, and upon receiving the collaboration request, perform mutually distributed knowledge collaboration.

The collaborative agent may use complicated situation recognition, cooperative simultaneous localization and mapping (C-SLAM), and a self-negotiator.

The collaborative agent may include: a multi-modal object data analysis unit configured to collect various pieces of multi-modal-based situation and environment data from the autonomous driving robots; and an inter-collaborative agent collaboration and negotiation unit configured to search a knowledge map through a resource management and situation inference unit to determine whether a mission model that is mapped to a goal state corresponding to the situation and environment data is present, check integrity and safety of multiple tasks in the mission, and transmit a multi-task sequence for planning an action plan for the individual tasks to an optimal action planning unit included in the inter-collaborative agent collaboration and negotiation unit, which is configured to analyze the tasks and construct an optimum combination of devices and knowledge to perform the tasks.

The collaborative agent may be constructed through a combination of the devices and knowledge on the basis of a cost benefit model.

The optimal action planning unit may perform refinement, division, and allocation on action-task sequences to deliver relevant tasks to the collaborative agents located in a distributed collaboration space on the basis of a generated optimum negotiation result.

The optimal action planning unit may deliver the relevant tasks through a knowledge/device search and connection protocol of a hyper-Intelligent network.

The multi-agent-based manned-unmanned collaboration system may further include an autonomous collaboration determination and global situation recognition unit configured to verify whether an answer for the goal state is satisfactory through global situation recognition monitoring using a delivered multi-task planning sequence using a collaborative determination and inference model and, when the answer is unsatisfactory, request the inter-collaborative agent collaboration/negotiation unit to perform mission re-planning to have a cyclic operation structure.

According to another aspect of the present invention, there is provided a multi-agent-based manned-unmanned collaboration method of performing sequential continuous collaborative positioning on the basis of wireless communication between robots providing location and spatial intelligence in a collaborative agent, the method including: transmitting and receiving information including location positioning information, by the plurality of robots, to sequentially move while forming a cluster; determining whether information having no location positioning information is received from a certain robot that has moved to a location for which no location positioning information is present among the robots forming the cluster; when it is determined that the information having no location positioning information is received from the certain robot in the determining, measuring a distance from the robots having remaining pieces of location positioning information at the moved location, in which location positioning is not performable, through a two-way-ranging (TWR) method; and measuring a location on the basis of the measured distance.

The measuring of the location may use a collaborative positioning-based sequential location calculation mechanism that includes calculating a location error of a mobile anchor serving as a positioning reference among the robots of which pieces of location information are identified and calculating a location error of a robot, of which a location is desired to be newly acquired, using the calculated location error of the mobile anchor and accumulating the location error.

The measuring of the location may include, with respect to a positioning network composed by the plurality of robots that form a workspace, when a destination deviates from the workspace, performing movements of certain divided ranges such that intermediate nodes move while expanding a coverage to a certain effective range (increasing d) rather than leaving the workspace at once.

The measuring of the location may use a full-mesh-based collaborative positioning algorithm in which each of the robots newly calculates locations of all anchor nodes to correct an overall positioning error.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a reference view illustrating a separable modular disaster relief snake robot and a method of driving the same according to the conventional technology;

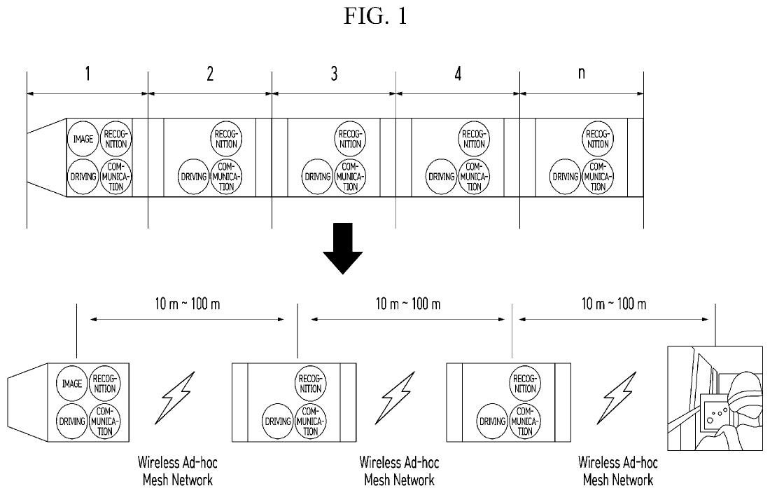

FIG. 2 is a functional block diagram for describing a multi-agent based manned-unmanned collaboration system according to an embodiment of the present invention;

FIG. 3 is a reference view for describing a connection structure of a multi-agent based collaborative manned-unmanned collaboration system according to an embodiment of the present invention;

FIG. 4 is a functional block diagram for describing a sensing device and a communication component among components of an autonomous driving robot shown in FIG. 2;

FIG. 5 is a functional block diagram for describing a component required for network connection and management among components of the autonomous driving robot shown in FIG. 2;

FIG. 6 is a functional block diagram for describing a configuration of a collaborative agent shown in FIG. 2;

FIG. 7 is a reference view for describing a function of a collaborative agent shown in FIG. 2;

FIG. 8 is a functional block diagram for processing an autonomous collaboration determination and global situation recognition function among functions of the collaborative agent shown in FIG. 2;

FIG. 9 is a reference view for describing a function of the collaborative agent shown in FIG. 2;

FIG. 10 is a flowchart for describing a multi-agent based manned-unmanned collaboration method according to an embodiment of the present invention;

FIGS. 11A to 11D are reference diagrams for describing a positioning method of an autonomous driving robot according to an embodiment of the present invention;

FIG. 12 is a view illustrating an example of calculating the covariance of collaborative positioning error when continuously using a two-way-ranging (TWR) based collaborative positioning technique according to an embodiment of the present invention;

FIG. 13 shows reference views illustrating a formation movement scheme capable of minimizing the covariance of collaborative positioning error according to an embodiment of the present invention; and

FIG. 14 shows reference views illustrating a full mesh based collaborative positioning method capable of minimizing the covariance of collaborative positioning error according to the present invention.

### DETAILED DESCRIPTION OF EXEMPLARY EMBODIMENTS

Hereinafter, the advantages and features of the present invention and ways of achieving them will become readily apparent with reference to descriptions of the following detailed embodiments in conjunction with the accompanying drawings. However, the present invention is not limited to such embodiments and may be embodied in various forms. The embodiments to be described below are provided only to complete the disclosure of the present invention and assist those of ordinary skill in the art in fully understanding the scope of the present invention, and the scope of the present invention is defined only by the appended claims. Terms used herein are used to aid in the explanation and understanding of the embodiments and are not intended to limit the scope and spirit of the present invention. It should be understood that the singular forms “a,” “an,” and “the” also include the plural forms unless the context clearly dictates otherwise. The terms “comprises,” “comprising,” “includes,” and/or “including,” when used herein, specify the presence of stated features, integers, steps, operations, elements, components and/or groups thereof and do not preclude the presence or addition of one or more other features, integers, steps, operations, elements, components, and/or groups thereof.

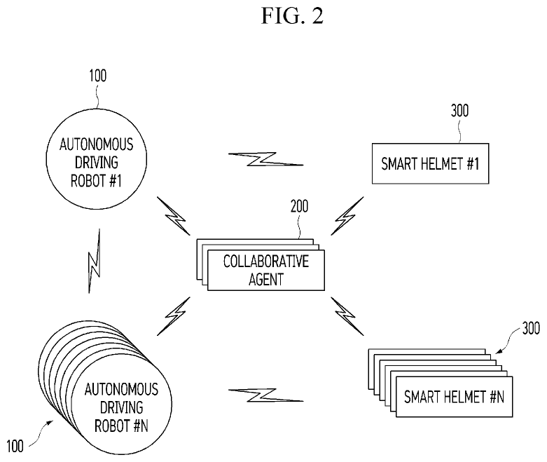

FIG. 2 is a functional block diagram for describing a multi-agent based manned-unmanned collaboration system according to an embodiment of the present invention.

Referring to FIG. 2, the multi-agent based manned-unmanned collaboration system according to the embodiment of the present invention includes a plurality of autonomous driving robots 100, a collaborative agent 200, and a plurality of smart helmets 300.

The plurality of autonomous driving robots 100 form a mesh network with neighboring autonomous driving robots 100, acquire visual information for generating situation recognition and spatial map information, and acquire distance information from the neighboring autonomous driving robots 100 to generate real-time location information.

The collaborative agent 200 constructs location positioning information of a collaboration object, target recognition information (vision intelligence), and spatial map information from the visual information, the location information, and the distance information collected from the autonomous driving robots 100, and provides information for supporting battlefield situational recognition, threat determination, and command decision using the generated spatial map information and the generated location information of the autonomous driving robot 100. Such a collaborative agent 200 may be provided in each of the autonomous driving robots 100 or may be provided on the smart helmet 300.

The plurality of smart helmets 300 display the location positioning information of the collaboration object, the target recognition information, and the spatial map information constructed through the collaborative agent and presents the pieces of information to wearers.

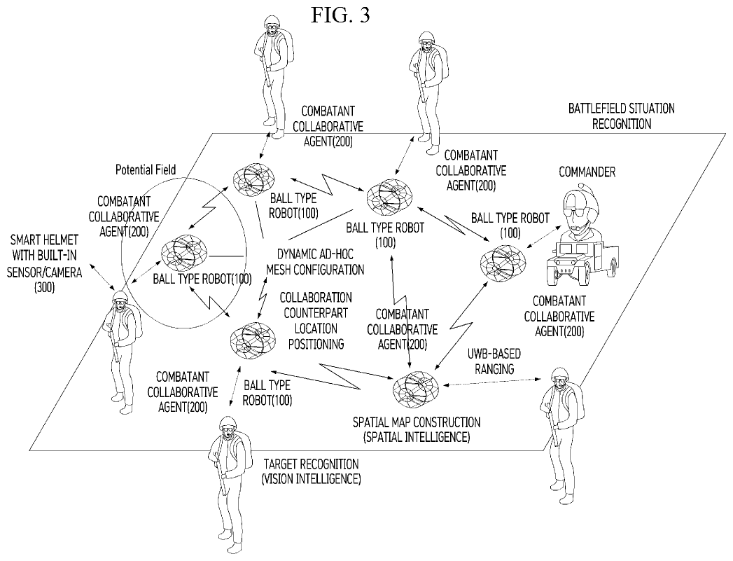

According to the embodiment of the present invention, referring to FIG. 3, through a collaborative agent based manned-unmanned collaboration method, an effect of providing a collaborative positioning methodology capable of supporting combatants in field situational recognition, threat determination, and command decision, providing wearers in a non-infrastructure environment with solid connectivity and spatial information based on an ad hoc network, and minimizing errors in providing real-time location information, and enhancing the survivability and combat power of the wearer is provided.

On the other hand, the autonomous driving robot 100 according to the embodiment of the present invention is provided in a ball type autonomous driving robot and drives autonomously along with the smart helmet 300 that is matched with the autonomous driving robot 100 in a potential field, which is a communication available area, and provides information for supporting local situational recognition, threat determination, and command decision of wears through a human-Robot-Interface (HRI) interaction.

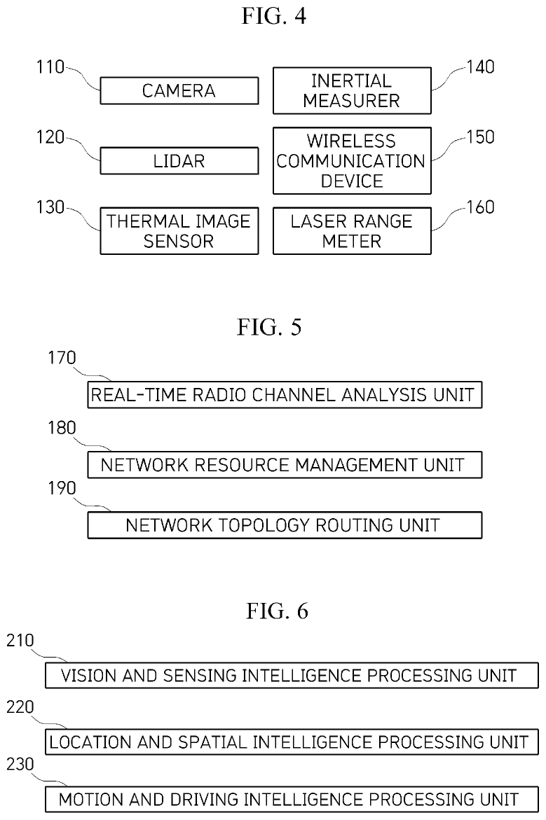

To this end, referring to FIG. 4, the autonomous driving robot 100 may include a sensing device, such as a camera 110, a Light Detection and Ranging (LiDAR) 120, and a thermal image sensor 130, for recognizing image information of a target object or recognizing a region and a space, an inertial measurer 140 for acquiring motion information of the autonomous driving robot 100, and a wireless communication device 150 for performing communication with the neighboring autonomous driving robot 100 and the smart helmet 300, and the autonomous driving robot 100 may further include a laser range meter 160.

The camera 110 captures image information to provide the wearer with visual information, the LiDAR 120 acquires object information using a laser by using an inertial measurement unit (IMU), and the thermal image sensor 130 acquires thermal image information of an object using thermal information.

The inertial measurer 140 acquires motion information of the autonomous driving robot 100.

The wireless communication device 150 constructs a dynamic ad-hoc mesh network with the neighboring autonomous driving robot 100 and transmits the acquired pieces of information to the matched smart helmet 300 through ultra-wideband (hereinafter referred to as “UWB”) communication. The wireless communication device 150 may preferably use UWB communication, but may use communication that supports a wireless local area network (WLAN), Bluetooth, a high-data-rate wireless personal area network (HDR WPAN), UWB, ZigBee, Impulse Radio, a 60 GHz WPAN, Binary-code division multi access (CDMA), wireless Universal Serial Bus (USB) technology, or wireless high-definition multimedia interface (HDMI) technology.

The laser range meter 160 measures the distance between an object to be recognized and a wall surrounding a space.

Preferably, the autonomous driving robot 100 is driven within a certain distance through UWB communication with the matched smart helmet 300.

In addition, preferably, the autonomous driving robot 100 performs WPAN based ad-hoc mesh network autonomous configuration management with the neighboring autonomous driving robot 100.

According to the embodiment of the present invention, an effect of allowing real-time spatial information to be shared between individual combatants and ensuring connectivity to enhance the survivability, combat power, and connectivity of the combatants in an atypical/non-infrastructure battlefield environment is provided.

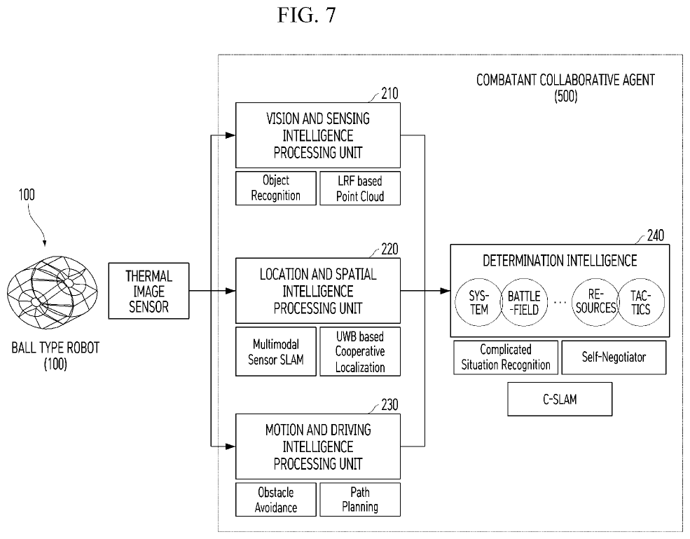

In addition, referring to FIG. 5, the autonomous driving robot 100 includes a real-time radio channel analysis unit 170, a network resource management unit 180, and a network topology routing unit 190.

The real-time radio channel analysis unit 170 analyzes a physical signal, such as a received signal strength indication (RSSI) and link quality information, with the neighboring autonomous driving robots 100.

The network resource management unit 180 analyzes traffic on a mesh network link with the neighboring autonomous driving robots 100 in real time.

The network topology routing unit 190 maintains a communication link without propagation interruption using information analyzed by the real-time radio channel analysis unit 170 and the network resource management unit 180.

According to the present invention, through the autonomous driving robot described above, an effect of supporting an optimal communication link to be maintained without propagation interruption between neighboring robots and performing real-time monitoring to prevent overload of a specific link is provided.

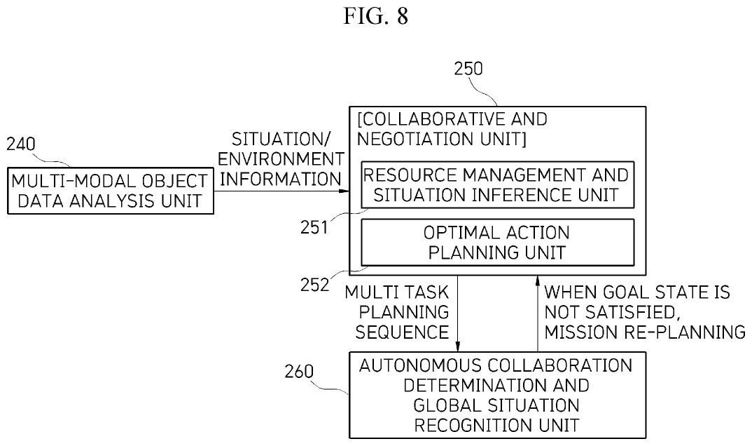

Meanwhile, referring to FIG. 6, the collaborative agent 200 includes a vision and sensing intelligence processing unit 210, a location and spatial intelligence processing unit 220, and a motion and driving intelligence processing unit 230.

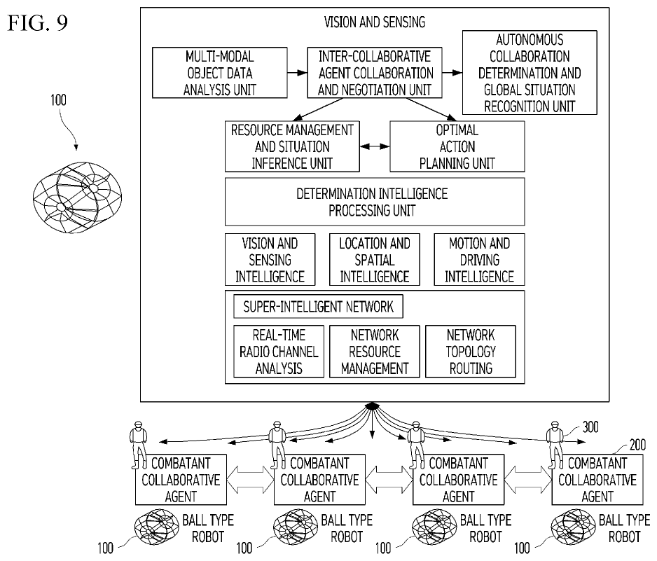

FIG. 7 is a reference view for describing the collaborative agent according to the embodiment of the present invention.

The vision and sensing intelligence processing unit 210 processes information about various objects and attitudes acquired through the autonomous driving robot 100 to recognize and classify a terrain, a landmark, and a target and generates a laser range finder (LRF)-based point cloud for producing a recognition map for each mission purpose.

In addition, the location and spatial intelligence processing unit 220 provides a visual-simultaneous localization and mapping (V-SLAM) function using a red-green-blue-depth (RGB-D) sensor, which is a camera of the autonomous driving rotor 100, a function of incorporating an LRF based point cloud function to generate a spatial map of a mission environment in real time, and a function of providing a sequential continuous collaborative positioning between the autonomous driving robots 100, each provided as a ball type autonomous driving robot, for location positioning of combatants having irregular flows using the UWB communication.

In addition, the motion and driving intelligence processing unit 230 provides a function of: autonomously setting a route plan according to a mission to explore a target and an environment of the autonomous driving robot 100, a mission to construct a dynamic ad-hoc mesh network for seamless connection and a mission of collaborative positioning between the ball-type autonomous driving robots 100 for real-time location positioning of the combatants; and avoiding a multimodal-based obstacle during driving of the autonomous driving robot 100.

In addition, the collaborative agent 200 generates a collaboration plan according to a mission, requests neighboring collaborative agents 200 to search for knowledge/devices available for collaboration and review the availability of the knowledge/devices, generates an optimal collaboration combination on the basis of a response to the request to transmit a collaboration request, and upon receiving the collaboration request, performs the mission through mutual distributed knowledge collaboration. Such a collaborative agent 200 may provide information about systems, battlefields, resources, and tactics through a determination intelligence processing unit 240, such as complicated situation recognition, coordinative simultaneous localization and mapping (C-SLAM), and a self-negotiator.

Meanwhile, in order to support a commander in command decision, the collaborative agent 200 combines the collected pieces of information to be subjected to artificial intelligence (AI) deep learning-based global situation recognition and C-SLAM technology to provide the commander with command decision information merged with unit spatial maps through the autonomous driving robot 100 linked with the smart helmet worn by the commander.

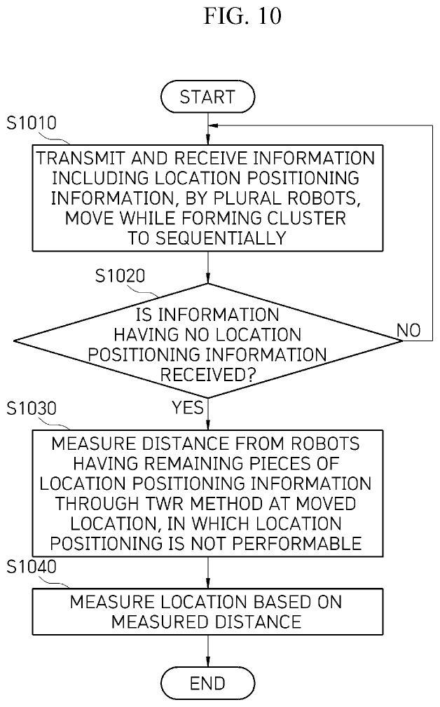

To this end, referring to FIG. 8, the collaborative agent 200 includes a multi-modal object data analysis unit 240, an inter-collaborative agent collaboration and negotiation unit 250, and an autonomous collaboration determination and global situation recognition unit 260 so that the collaborative agent 200 serves as a supervisor of the overall system.

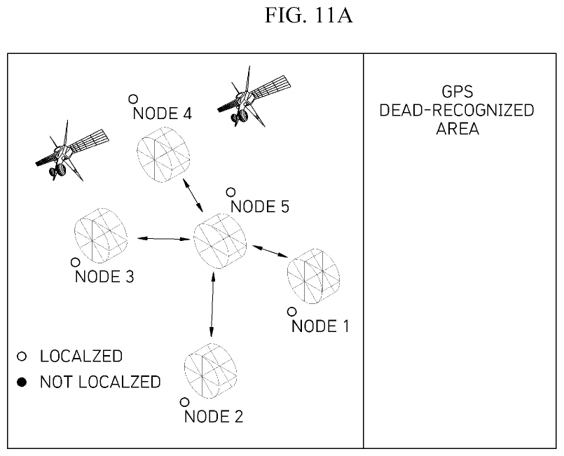

FIG. 9 is a reference view for describing a management agent function of the collaborative agent according to the embodiment.

The multi-modal object data analysis unit 240 collects various pieces of multi-modal based situation and environment data from the autonomous driving robots 100.

In addition, the inter-collaborative agent collaboration and negotiation unit 250 searches a knowledge map through a resource management and situation inference unit 251 to determine whether a mission model that is mapped to a goal state corresponding to the situation and environment data is present, checks integrity and safety of multiple tasks in the mission, and transmits a multi-task sequence for planning an action plan for the individual tasks to an optimal action planning unit 252 so that the tasks are analyzed and an optimum combination of devices and knowledge to perform the tasks is constructed.

Preferably, the management agent is constructed through a combination of devices and knowledge that may maximize profits with the lowest cost on the basis of a cost benefit model.

On the other hand, the optimal action planning unit 252 performs refinement/division/allocation on action-task sequences to deliver relevant tasks to the collaborative agents located in a distributed collaboration space on the basis of a generated optimum negotiation result through a knowledge/device search and connection protocol of a hyper-intelligence network formed through the autonomous driving robots 100 so as to deliver the relevant tasks to wearers of the respective smart helmets 300.

In addition, the autonomous collaboration determination and global situation recognition unit 260 verifies whether an answer for the goal state is satisfactory through global situation recognition monitoring using a delivered multi-task planning sequence using a collaborative determination/inference model and, when the answer is unsatisfactory, requests the inter-collaborative agent collaboration and negotiation unit 250 to perform mission re-planning to have a cyclic operation structure.

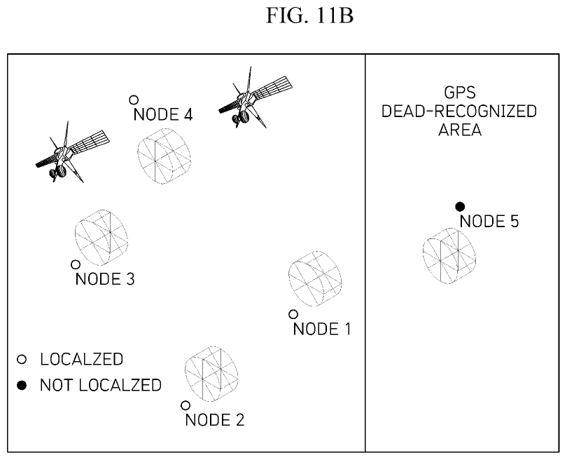

FIG. 10 is a flowchart showing a sequential continuous collaborative positioning procedure based on UWB communication between autonomous driving robots, which is provided by a location and spatial intelligence processing unit in the combatant collaborative agent according to the characteristics of the present invention.

Hereinafter, a multi-agent based-manned-unmanned collaboration method according to an embodiment of the present invention will be described with reference to FIG. 10.

First, the plurality of autonomous driving robots 100 transmit and receive information including location positioning information to sequentially move while forming a cluster (S1010).

Whether information having no location positioning information is received from a certain autonomous driving robot 100 that has moved to a location, for which no location positioning information is present, among the autonomous driving robots 100 forming the cluster is determined (S1020).

When it is determined in the determination operation S1020 that the information having no location positioning information is received from the certain autonomous driving robot 100 (YES in operation S1020), a distance from the autonomous driving robots having the remaining pieces of location positioning information is measured through a two-way-ranging (TWR) method at the moved location, in which the location positioning is not performable (S1030).

Then, the location is measured on the basis of the measured distance (S1040).

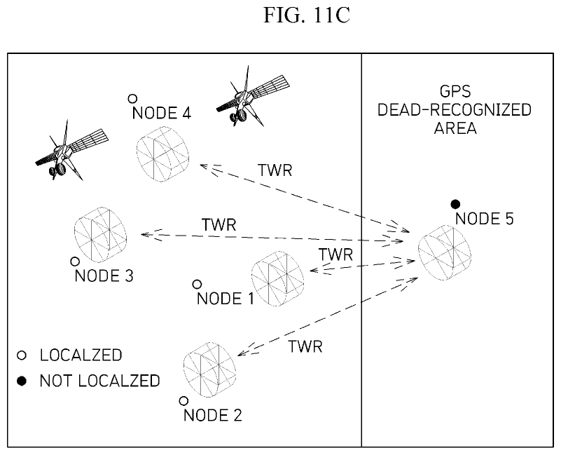

That is, the autonomous driving robots 100 (node-1 to node-5) acquire location information from a global positioning system (GPS) device as shown in FIG. 11A, and when an autonomous driving robot 100 (node-5) moves to a location (a GPS dead-recognized area) in a new effective range as shown in FIG. 11B, the autonomous driving robot 100 (node-5) located in the GPS dead-recognized area calculates location information through TWR communication with the autonomous driving robots (node-1 to node-4) of which pieces of location information are identifiable, as shown in FIG. 11C. When another autonomous driving robot 100 (node-1) moves to the location (the GPS dead-recognized area) in the new effective range as shown in FIG. 11D, the autonomous driving robot 100 (node-1) calculates location information through TWR communication with the neighboring autonomous driving robots 100 (node-2 to node-5), which is sequentially repeated so that collaborative positioning proceeds.

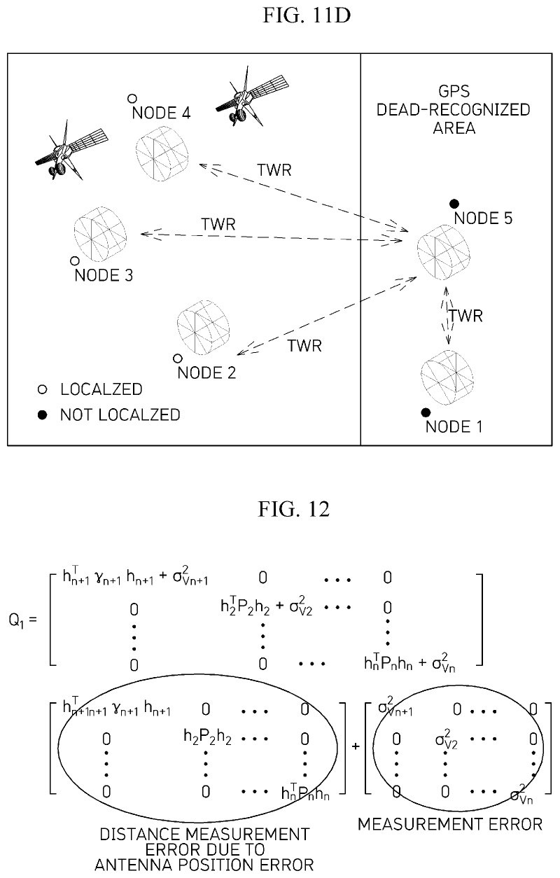

FIG. 12 is a view illustrating an example of calculating the covariance of collaborative positioning error when continuously using the TWR-based collaborative positioning technique according to the embodiment of the present invention.

Referring to FIG. 12, preferably, the operation S1040 of measuring the location uses a collaborative positioning-based sequential location calculation mechanism of: calculating a location error of a mobile anchor (one of the autonomous driving robots 100, of which pieces of location information are identified) serving as a positioning reference; and accumulating a location error of a new mobile tag (a ball-type autonomous driving robot of which location information is desired to be newly acquired) to be subjected to location acquisition using the calculated location error of the mobile anchor.

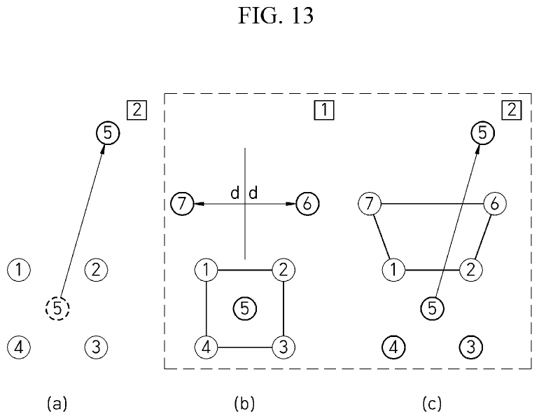

FIG. 13 shows reference views illustrating a formation movement scheme capable of minimizing the covariance of collaborative positioning error according to the embodiment of the present invention.

The operation S1040 of measuring the location includes, when destination 1 of an anchor \textcircled{5} located in a workspace composed by a plurality of anchors \textcircled{1}, \textcircled{2}, \textcircled{3}, and \textcircled{4} is distant, performing sequential movements of certain divided ranges as shown in FIG. 13B, rather than leaving the workspace at once as shown in FIG. 13A.

First, the anchor \textcircled{4} moves to the location of an anchor \textcircled{7}, and the anchor \textcircled{3} moves to the location of an anchor \textcircled{6} to form a new workspace, and then the anchor \textcircled{5} moves to the destination 2 so that movement is performable while maintaining the continuity of the communication network. In this case, preferably, the intermediate nodes \textcircled{3} and \textcircled{4} may move while expanding a coverage (increasing d) to a certain effective range.

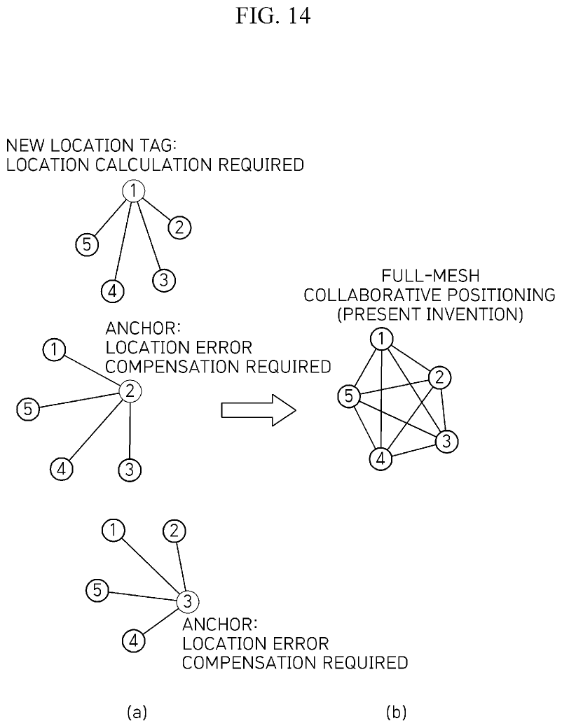

FIGS. 14A and 14B are reference views illustrating a full mesh based collaborative positioning method capable of minimizing the covariance of collaborative positioning error according to the present invention

The operation S1040 of measuring the location includes using a full-mesh based collaborative positioning algorithm in which each of the autonomous driving robots 100 newly calculates locations of all anchor nodes to correct an overall positioning error.

That is, when an anchor \textcircled{1} is located at a new location, the anchor \textcircled{1} detects location positioning through communication with neighboring anchors \textcircled{2} and \textcircled{5} that form a workspace as shown in FIG. 14A. In this case, according to the full mesh based collaborative positioning method, other anchors \textcircled{2} to \textcircled{5} forming the workspace also perform collaborative positioning as shown in FIG. 14B.

When using such a full mesh based collaborative positioning method, the calculation amount of each anchor may be increased, but an effect of increasing the positioning accuracy of each anchor may be provided.

For reference, the elements according to the embodiment of the present invention may each be implemented in the form of software or in the form of hardware such as a field programmable gate array (FPGA) or an application specific integrated circuit (ASIC) and may perform certain functions.

However, the elements are not limited to software or hardware in meaning. In other embodiments, each of the elements may be configured to be stored in a storage medium capable of being addressed or may be configured to execute one or more processors.

Therefore, for example, the elements may include elements such as software elements, object-oriented software elements, class elements, and task elements, processes, functions, attributes, procedures, subroutines, segments of a program code, drivers, firmware, microcode, circuits, data, databases, data structures, tables, arrays, and variables.

Elements and a function provided in corresponding elements may be combined into fewer elements or may be further divided into additional elements.

It should be understood that the blocks and the operations shown in the drawings can be performed via computer programming instructions. These computer programming instructions can be installed on processors of data processing equipment that can be programmed, special computers, or universal computers. The instructions, performed via the processors of data processing equipment or the computers, can generate a means that performs functions described in a block (blocks) of the flow chart. In order to implement functions in a particular mode, the computer programming instructions can also be stored in a computer available memory or computer readable memory that can support computers or data processing equipment that can be programmed. Therefore, the instructions, stored in the computer available memory or computer readable memory, can produce an article of manufacture containing instruction means that perform the functions described in the blocks of the flowchart therein). In addition, since the computer programming instructions can also be installed on computers or data processing equipment that can be programmed, they can create processes that are executed by a computer through a series of operations that are performed on a computer or other programmable data processing equipment so that the instructions performing the computer or other programmable data processing equipment can provide operations for executing the functions described in the blocks of the flowchart.

The blocks of the flow chart refer to part of codes, segments or modules that include one or more executable instructions to perform one or more logic functions. It should be noted that the functions described in the blocks of the flow chart may be performed in a different order from the embodiments described above. For example, the functions described in two adjacent blocks may be performed at the same time or in reverse order.

In the embodiments, the terminology, component “unit,” refers to a software element or a hardware element such as a FPGA, an ASIC, etc., and performs a corresponding function. It should, however, be understood that the component “unit” is not limited to a software or hardware element. The component “unit” may be implemented in storage media that can be designated by addresses. The component “unit” may also be configured to regenerate one or more processors. For example, the component “unit” may include various types of elements (e.g., software elements, object-oriented software elements, class elements, task elements, etc.), segments (e.g., processes, functions, achieves, attribute, procedures, sub-routines, program codes, etc.), drivers, firmware, micro-codes, circuit, data, data base, data structures, tables, arrays, variables, etc. Functions provided by elements and the components “units” may be formed by combining the small number of elements and components “units” or may be divided into additional elements and components “units.” In addition, elements and components “units” may also be implemented to regenerate one or more CPUs in devices or security multi-cards.

As is apparent from the above, the present invention can enhance the survivability and combat power of combatants by providing a new collaborative positioning methodology that supports combatants in battlefield situational recognition, threat determination, and command decision, provides combatants in a non-infrastructure environment with solid connectivity and spatial information based on an ad hoc network, and minimizes errors in providing real-time location information through a collaborative agent based manned-unmanned collaboration method.

Although the present invention has been described in detail above with reference to the exemplary embodiments, those of ordinary skill in the technical field to which the present invention pertains should be able to understand that various modifications and alterations may be made without departing from the technical spirit or essential features of the present invention. The scope of the present invention is not defined by the above embodiments but by the appended claims of the present invention.

Each step included in the learning method described above may be implemented as a software module, a hardware module, or a combination thereof, which is executed by a computing device.

Also, an element for performing each step may be respectively implemented as first to two operational logics of a processor.

The software module may be provided in RAM, flash memory, ROM, erasable programmable read only memory (EPROM), electrical erasable programmable read only memory (EEPROM), a register, a hard disk, an attachable/detachable disk, or a storage medium (i.e., a memory and/or a storage) such as CD-ROM.

An exemplary storage medium may be coupled to the processor, and the processor may read out information from the storage medium and may write information in the storage medium. In other embodiments, the storage medium may be provided as one body with the processor.

The processor and the storage medium may be provided in application specific integrated circuit (ASIC). The ASIC may be provided in a user terminal. In other embodiments, the processor and the storage medium may be provided as individual components in a user terminal.

Exemplary methods according to embodiments may be expressed as a series of operation for clarity of description, but such a step does not limit a sequence in which operations are performed. Depending on the case, steps may be performed simultaneously or in different sequences.

In order to implement a method according to embodiments, a disclosed step may additionally include another step, include steps other than some steps, or include another additional step other than some steps.

Various embodiments of the present disclosure do not list all available combinations but are for describing a representative aspect of the present disclosure, and descriptions of various embodiments may be applied independently or may be applied through a combination of two or more.

Moreover, various embodiments of the present disclosure may be implemented with hardware, firmware, software, or a combination thereof. In a case where various embodiments of the present disclosure are implemented with hardware, various embodiments of the present disclosure may be implemented with one or more application specific integrated circuits (ASICs), digital signal processors (DSPs), digital signal processing devices (DSPDs), programmable logic devices (PLDs), field programmable gate arrays (FPGAs), general processors, controllers, microcontrollers, or microprocessors.

The scope of the present disclosure may include software or machine-executable instructions (for example, an operation system (OS), applications, firmware, programs, etc.), which enable operations of a method according to various embodiments to be executed in a device or a computer, and a non-transitory computer-readable medium capable of being executed in a device or a computer each storing the software or the instructions.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multi-agent-based manned-unmanned collaboration system comprising:
a plurality of autonomous driving robots configured to form a mesh network with neighboring autonomous driving robots, acquire visual information for generating situation recognition and spatial map information, and acquire distance information from the neighboring autonomous driving robots to generate location information in real time;
a collaborative agent configured to construct location positioning information of a collaboration object, target recognition information, and spatial map information from the visual information, the location information, and the distance information collected from the autonomous driving robots, and provide information for supporting battlefield situational recognition, threat determination, and command decision using the generated spatial map information and the generated location information of the autonomous driving robot; and
a plurality of smart helmets configured to display the location positioning information of the collaboration object, the target recognition information, and the spatial map information constructed through the collaborative agent and present the pieces of information to wearers.

2. The multi-agent-based manned-unmanned collaboration system of claim 1, wherein the autonomous driving robot includes:
a camera configured to acquire image information;
a Light Detection and Ranging (LiDAR) configured to acquire object information using a laser;
a thermal image sensor configured to acquire thermal image information of an object using thermal information;
an inertial measurer configured to acquire motion information;
a wireless communication unit which configures a dynamic ad-hoc mesh network with the neighboring autonomous driving robots through wireless network communication and transmits the pieces of acquired information to the smart helmet that is matched with the autonomous driving robot; and
a laser range meter configured to measure a distance between a recognition target object and a wall surrounding a space.

3. The multi-agent-based manned-unmanned collaboration system of claim 1, wherein the autonomous driving robot is driven within a certain distance from the matched smart helmet through ultra-wideband (UWB) communication.

4. The multi-agent-based manned-unmanned collaboration of claim 1, wherein the autonomous driving robot drives autonomously according to the matched smart helmet and provides information for supporting local situation recognition, threat determination, and command decision of the wearer through a human-robot interface (HRI) interaction.

5. The multi-agent-based manned-unmanned collaboration system of claim 1, wherein the autonomous driving robot performs autonomous-configuration management of a wired personal area network (WPAN) based ad-hoc mesh network with the neighboring autonomous driving robot.

6. The multi-agent-based manned-unmanned collaboration system of claim 5, wherein the autonomous driving robot includes:
a real-time radio channel analysis unit configured to analyze a physical signal including a received signal strength indication (RSSI) and link quality information with the neighboring autonomous driving robots;
a network resource management unit configured to analyze traffic on a mesh network link with the neighboring autonomous robots in real time; and
a network topology routing unit configured to maintain a communication link without propagation interruption using information analyzed by the real-time radio channel analysis unit and the network resource management unit.

7. The multi-agent-based manned-unmanned collaboration system of claim 1, wherein the collaborative agent includes:
a vision and sensing intelligence processing unit configured to process information about various objects and attitudes acquired through the autonomous driving robot to recognize and classify a terrain, a landmark, and a target and to generate a laser range finder (LRF)-based point cloud for producing a recognition map for each mission purpose;
a location and spatial intelligence processing unit configured to provide a visual-simultaneous localization and mapping (V-SLAM) function using a camera of the autonomous driving rotor, a function of incorporating an LRF-based point cloud function to generate a spatial map of a mission environment in real time, and a function of providing a sequential continuous collaborative positioning function between the autonomous driving robots for location positioning of combatants having irregular flows using UWB communication; and
a motion and driving intelligence processing unit which explores a target and an environment of the autonomous driving robot, configures a dynamic ad-hoc mesh network for seamless connection, autonomously sets a route plan according to collaboration positioning between the autonomous robots for real-time location positioning of the combatants, and provides information for avoiding a multimodal-based obstacle during driving of the autonomous driving robot.

8. The multi-agent-based manned-unmanned collaboration system of claim 7, wherein the collaborative agent is configured to:
generate a collaboration plan according to intelligence processing;
request neighboring collaboration agents to search for knowledge and devices available for collaboration and review availability of the knowledge and devices;
generate an optimal collaboration combination on the basis of a response to the request to transmit a collaboration request; and
upon receiving the collaboration request, perform mutually distributed knowledge collaboration.

9. The multi-agent-based manned-unmanned collaboration system of claim 7, wherein the collaborative agent uses complicated situation recognition, cooperative simultaneous localization and mapping (C-SLAM), and a self-negotiator.

10. The multi-agent-based manned-unmanned collaboration system of claim 7, wherein the collaborative agent includes:
a multi-modal object data analysis unit configured to collect various pieces of multi-modal-based situation and environment data from the autonomous driving robots; and
an inter-collaborative agent collaboration and negotiation unit configured to search a knowledge map through a resource management and situation inference unit to determine whether a mission model that is mapped to a goal state corresponding to the situation and environment data is present, check integrity and safety of multiple tasks in the mission, and transmit a multi-task sequence for planning an action plan for the individual tasks to an optimal action planning unit included in the inter-collaborative agent collaboration and negotiation unit, which is configured to analyze the tasks and construct an optimum combination of devices and knowledge to perform the tasks.

11. The multi-agent-based manned-unmanned collaboration system of claim 10, wherein the collaborative agent is constructed through a combination of the devices and knowledge on the basis of a cost benefit model.

12. The multi-agent-based manned-unmanned collaboration system of claim 11, wherein the optimal action planning unit performs refinement, division, and allocation on action-task sequences to deliver relevant tasks to the collaborative agents located in a distributed collaboration space on the basis of a generated optimum negotiation result.

13. The multi-agent-based manned-unmanned collaboration system of claim 12, wherein the optimal action planning unit delivers the relevant tasks through a knowledge/device search and connection protocol of a hyper-Intelligent network.

14. The multi-agent-based manned-unmanned collaboration system of claim 10, further comprising an autonomous collaboration determination and global situation recognition unit configured to verify whether an answer for the goal state is satisfactory through global situation recognition monitoring using a delivered multi-task planning sequence using a collaborative determination and inference model and, when the answer is unsatisfactory, request the inter-collaborative agent collaboration/negotiation unit to perform mission re-planning to have a cyclic operation structure.

15. A multi-agent-based manned-unmanned collaboration method of performing sequential continuous collaborative positioning on the basis of wireless communication between robots providing location and spatial intelligence in a collaborative agent, the method comprising:
transmitting and receiving information including location positioning information, by the plurality of robots, to sequentially move while forming a cluster;
determining whether information having no location positioning information is received from a certain robot that has moved to a location for which no location positioning information is present among the robots forming the cluster;
when it is determined that the information having no location positioning information is received from the certain robot in the determining, measuring a distance from the robots having remaining pieces of location positioning information at the moved location, in which location positioning is not performable, through a two-way-ranging (TWR) method; and
measuring a location on the basis of the measured distance.

16. The multi-agent-based manned-unmanned collaboration method of claim 15, wherein the measuring of the location uses a collaborative positioning-based sequential location calculation mechanism that includes:
calculating a location error of a mobile anchor serving as a positioning reference among the robots of which pieces of location information are identified; and
calculating a location error of a robot, of which a location is desired to be newly acquired, using the calculated location error of the mobile anchor and accumulating the location error.

17. The multi-agent-based manned-unmanned collaboration method of claim 16, wherein the measuring of the location includes, with respect to a positioning network composed by the plurality of robots that form a workspace,
when a destination deviates from the workspace, performing movements of certain divided ranges such that intermediate nodes move while expanding a coverage to a certain effective range (increasing d) rather than leaving the workspace at once.

18. The multi-agent-based manned-unmanned collaboration method of claim 15, wherein the measuring of the location uses a full-mesh-based collaborative positioning algorithm in which each of the robots newly calculates locations of all anchor nodes to correct an overall positioning error.
